(19) United States
(12) Patent Application Publication
(10) Pub. No.: US 2014/0083244 A1
(43) Pub. Date: Mar. 27, 2014

(54) PROTECTIVE DEVICE FOR SLIDING SURFACE

(71) Applicant: OKUMA CORPORATION, Niwa-Gun (JP)

(72) Inventor: Wataru SEGAWA, Niwa-Gun (JP)

(73) Assignee: OKUMA CORPORATION, Niwa-Gun (JP)

(21) Appl. No.: 13/857,417

(22) Filed: Apr. 5, 2013

(30) Foreign Application Priority Data
Sep. 24, 2012 (JP) 2012-209834

(51) Int. Cl. F16P 1/02

(52) U.S. Cl. CPC F16P 1/02
USPC 74/608

(57) ABSTRACT

Cover frames configure a slide cover. Each of the cover frames has, at a lower end thereof, a wiper that contacts an outer surface of the cover frame located immediate inside. Each of the cover frames also has, on an upper inner surface thereof, a roof-shaped backboard that extends over the cover frame inside. The backboard is provided slightly below an upper end of the cover frame. Each of the cover frames is provided, on an upper outer surface thereof, with a sliding shoe that contacts an inner surface of the cover frame located immediate outside. The innermost cover frame is fixed to a column in which a sliding surface is formed, and has a bottom plate that encloses an area below the sliding surface. In an upper portion of the bottom plate, an oil receiving portion is formed to receive lubricant flowing from the sliding surface.

### BACKGROUND OF THE INVENTION

This application claims the benefit of Japanese Patent Application Number 2012-209834 filed on Sep. 24, 2012, the entirety of which is incorporated by reference.

### TECHNICAL FIELD

The present invention relates to a protective device for a sliding surface, which protects a sliding surface of a machine tool from chips and the like, and in particular, relates to a protective device for a sliding surface, which protects a sliding surface formed so as to extend in the vertical direction.

### BACKGROUND ART

A protective device for a sliding surface that extends in the vertical direction is provided as shown in FIG. 4, for example. In FIG. 4, the protective device for a sliding surface has a slide cover 22 in which cover frames 21 are overlapped and connected so that the slide cover 22 extends and contracts. A sliding surface 23a is always protected from chips and the like by the slide cover 22 that extends and contracts as a movable body 24 moves on the sliding surface 23a in the vertical direction. An oil receiving pan 25 is provided below the slide cover 22 to collect lubricant that flows along the sliding surface 23a.

In contrast, a device for collecting lubricant, which collects lubricant that flows along a sliding surface formed in the vertical direction is disclosed in Japanese Utility Model Application Publication No. 2-82451. In Japanese Utility Model Application Publication No. 2-82451, the slide cover is used to cover the sliding surface so that cutting fluid and the like outside the slide cover are not mixed with lubricant inside the cover, and the lubricant is collected in a container formed integrally with the lowermost cover frame.

With the configuration shown in FIG. 4, cutting fluid that spatters and adheres to the slide cover 22 flows on the slide cover 22 into the oil receiving pan 25, and is mixed with the lubricant. FIG. 5 schematically shows this event.

Moreover, with the configuration in Japanese Utility Model Application Publication No. 2-82451, the container to collect the lubricant is provided inside the slide cover, which can solve the problem of inclusion of the cutting fluid when compared to the construction in FIG. 4. However, an engagement piece horizontally placed in the upper portion of a cylinder, which is a cover frame, contacts a flat guide plate of a cylindrical portion. Thus, the lubricant that adheres to the guide plate is likely to flow to the front side of the slide cover through the engagement piece.

### SUMMARY OF THE INVENTION

In view of the problems, the present invention is intended to provide a protective device for a sliding surface, in which lubricant on the sliding surface extending in the vertical direction does not leak outside and chips and cutting fluid do not enter an oil receiving pan for the lubricant and are not mixed with the lubricant.

To solve the problems, a protective device for a sliding surface according to a first aspect of the present invention includes a slide cover that includes a plurality of cover frames overlapped and connected, that is provided so as to cover a portion of a sliding surface located below a movable body. The sliding surface allows the movable body to move in a vertical direction thereon. The slide cover extends and contracts as the movable body moves, and protects the sliding surface from chips and cutting fluid. Each of the cover frames has a wiper at a lower end thereof, and the wiper contacts an outer surface of the cover frame which is located immediate inside. Each of the cover frames has a backboard on an upper inner surface thereof, and the backboard is formed in a roof shape and extends over the cover frame inside. The backboard is provided slightly below an upper end of the cover frame, with such a depth that a predetermined gap is formed between the sliding surface and the backboard.

Because of the predetermined gap formed between the backboards of the cover frames and the sliding surface, the cover frames do not contact the sliding surface, and the lubricant that flows from the movable body to the sliding surface does not flow to the outside of the cover frames. Moreover, if the lubricant on the sliding surface spatters toward the cover frames, the lubricant is received by the backboards and drops below the sliding surface. Accordingly, the lubricant does not flow to the outside of the slide cover.

Meanwhile, cutting fluid that adheres to the surface of the slide cover does not enter the inside of the slide cover, and thus is not mixed with the lubricant inside the cover frames. Therefore, it is possible to collect the lubricant that does not contain the cutting fluid and chips and to prevent the cutting fluid from being mixed with the lubricant.

According to a second aspect of the present invention, in the configuration according to the first aspect, each of the cover frames may have side portions which are formed by bending left and right ends thereof to cover left and right sides of a base in which the sliding surface is formed. The cover frames may be telescopically connected, and each of the cover frames may be provided, on an upper outer surface thereof, with a sliding shoe that contacts the cover frame which is located immediate outside.

With this configuration, gaps between the cover frames that are telescopically connected keep predetermined width by the sliding shoes, so that backboards do not contact the sliding surface as a result of deflection of the cover frames. Therefore, the cutting fluid does not enter from the outside of the cover frames and the lubricant on the sliding surface does not flow to the backboard.

According to a third aspect of the present invention, in the configuration according to the first aspect or the second aspect, the innermost cover frame among the cover frames may have, at a lower end thereof, a bottom plate that is connected to the base in which the sliding surface is formed. The bottom plate may also serve as an oil receiving portion that encloses an area below the sliding surface and receives lubricant that flows from the sliding surface.

With this configuration, the oil receiving portion that collects the lubricant is formed integrally with the cover frame, which separates the outer side of the slide cover 3. Thus, the lubricant does not flow to the outer side and the cutting fluid that adheres to the slide cover does not enter the oil receiving portion.

According to the above aspects of the present invention, a predetermined gap is provided between the backboards of the cover frames and the sliding surface. Therefore, the cover frames do not contact the sliding surface, and the lubricant that flows from the movable body to the sliding surface does not flow to the outside of the cover frames. Moreover, if the lubricant on the sliding surface spatters toward the cover frames, the lubricant is received by the backboards and drops below the sliding surface. Accordingly, the lubricant does not flow to the outside of the cover frames, namely, the outside of the slide cover.

Meanwhile, the cutting fluid that adheres to the surface of the slide cover does not enter the inside of the slide cover, and thus is not mixed with the lubricant inside the cover frames. Therefore, it is possible to collect the lubricant that does not contain the cutting fluid and chips and to prevent the cutting fluid from being mixed with the lubricant.

### BRIEF DESCRIPTION OF THE DRAWINGS

FIG. 1 is a longitudinal sectional view showing an example of a protective device for a sliding surface and how lubricant flows according to the present invention.

FIG. 2 is a longitudinal sectional view showing how cutting fluid adheres to the protective device for a sliding surface in FIG 1.

FIG. 3 is a cross-sectional view taken along line A-A in FIG. 1 and showing a lateral section of the protective device for a sliding surface.

FIG. 4 is a longitudinal sectional view showing a conventional protective device for a sliding surface and how lubricant flows.

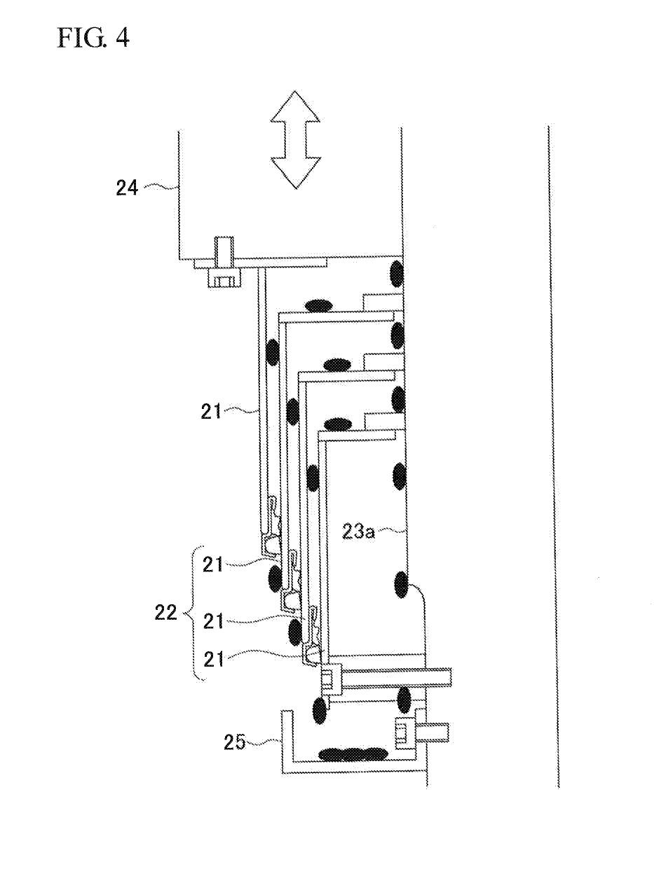

FIG. 5 is a longitudinal sectional view showing how cutting fluid adheres to the protective device for a sliding surface in FIG. 4.

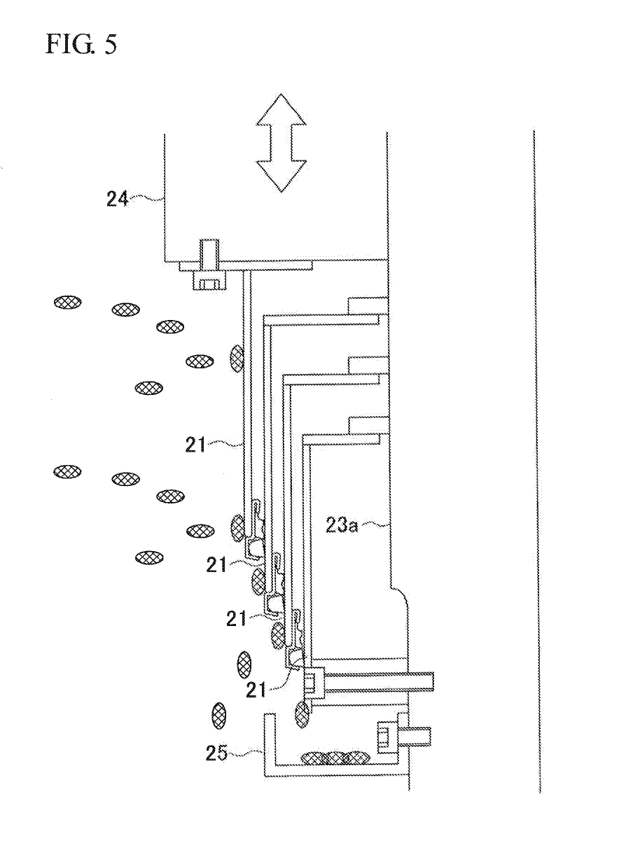

### DETAILED DESCRIPTION OF THE EMBODIMENTS

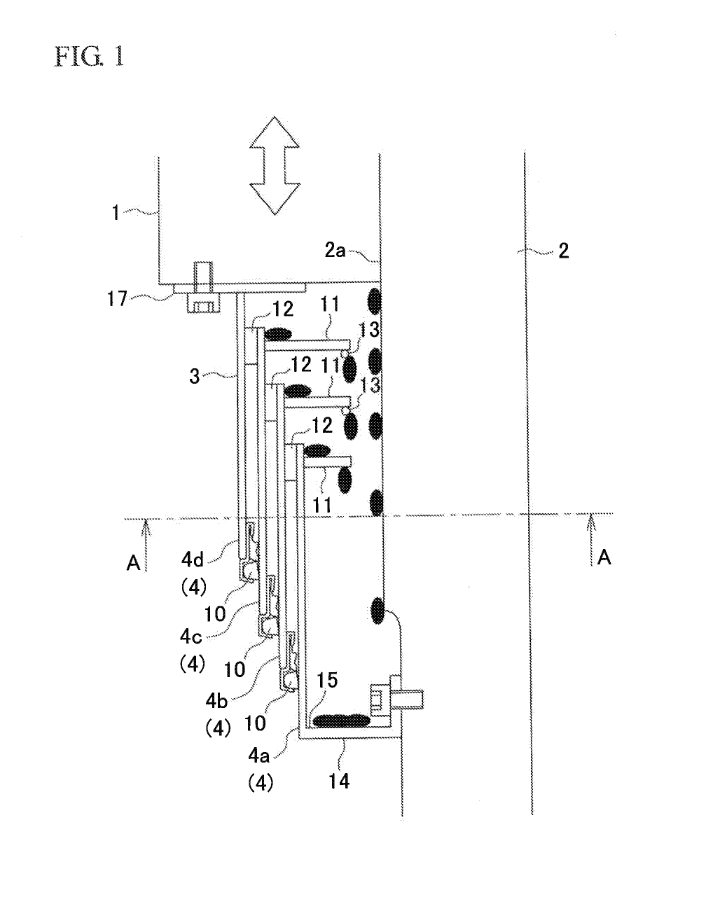

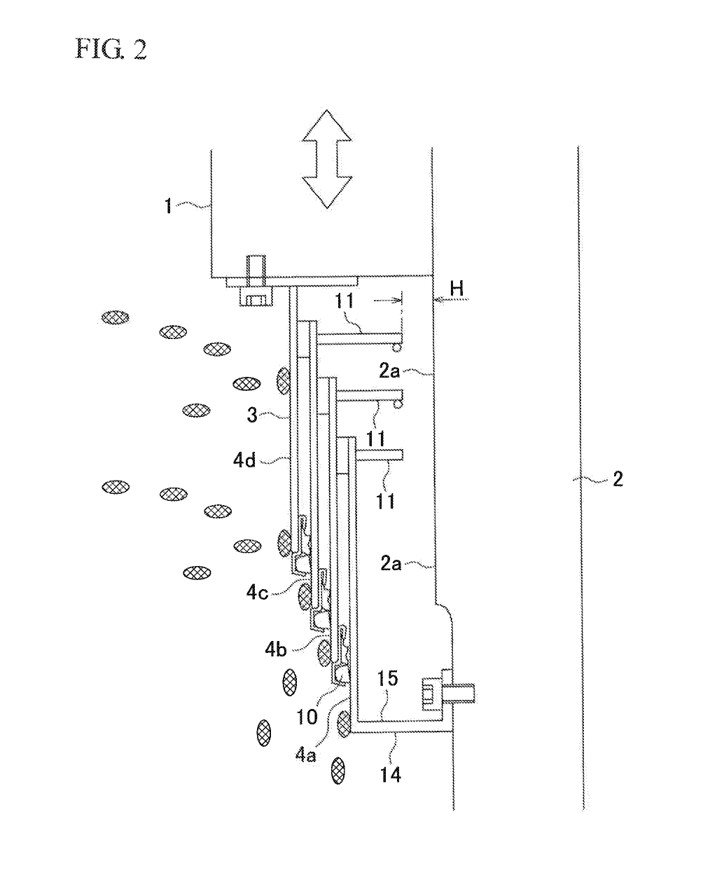

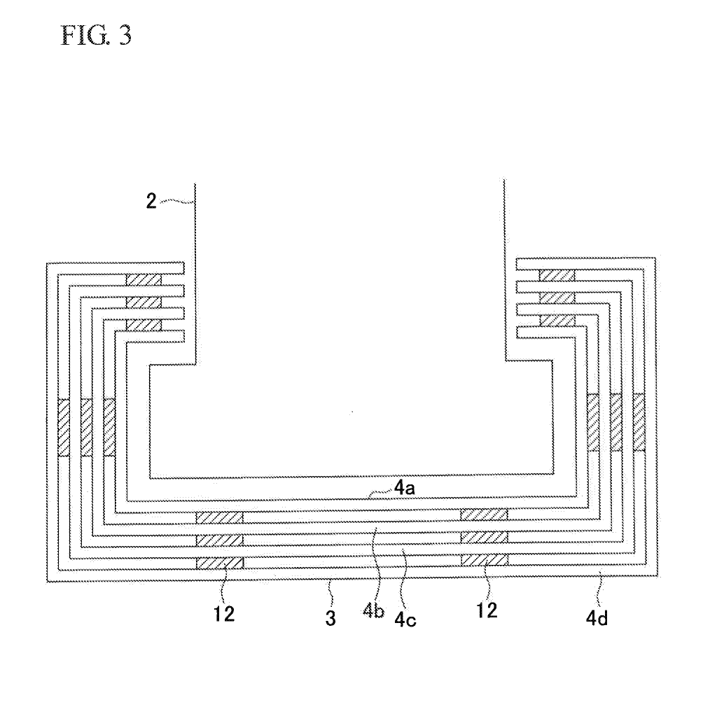

An embodiment of the present invention will be described in detail with reference to the attached drawings. FIGS. 1 and 2 show an example of a protective device for a sliding surface of the present invention. FIG. 1 also shows how lubricant flows and FIG. 2 shows how cutting fluid adheres to the protective device for a sliding surface. FIG. 3 shows a lateral section taken along line A-A.

Reference numeral 1 denotes a cross rail serving as a movable body that moves in the vertical direction. Reference numeral 2 denotes a column that has a sliding surface 2a extending in the vertical direction so as to allow the cross rail 1 to move. Reference numeral 3 denotes a slide cover that protects the sliding surface 2a from chips and the like. The slide cover 3 is contracted (the cross rail 1 has moved to the lowermost position) in both FIG. 1 and FIG. 2. It should be noted that left side in FIG. 1 corresponds to the “front” side and right side corresponds to “rear” side.

The slide cover 3 is formed such that cover frames 4 are overlapped (in FIG. 1, four cover frames 4a, 4b, 4c, and 4d are overlapped) and connected so that the slide cover 3 extends and contracts. Specifically, as shown in the lateral section in FIG. 3, both left and right ends of each of the cover frames 4 are bent backward in a generally U shape, and the cover frames 4 are arranged in a telescopic configuration. The bent side plates of the cover frames 4 extend to cover the back of the column 2 in which the sliding surface 2a is formed. Each inner cover frame 4 is set lower than the previous one. The lowermost cover frame 4a is fixedly connected to the column 2, and the uppermost cover frame 4d is connected to the cross rail 1.

The number of overlapped cover frames 4 may be changed based on the width and length of the sliding surface 2a.

Each of the cover frames 4b to 4d except the lowermost cover frame 4a has a wiper 10 at a lower end thereof. Each of the cover frames 4a to 4c except the uppermost cover frame 4d has a backboard 11 and sliding shoes 12 in the upper portion thereof Each of the wipers 10 extends laterally so as to slide on the surface of the cover frame 4 which is located immediate inside.

The backboards 11 are provided to enhance the rigidity of the cover frames 4 and to prevent deflection of the cover frames 4. The backboards 11 are each formed in a roof-shape at a position slightly below the upper end of the corresponding cover frame 4 (for example, 10 mm below the upper end of the cover frame 4). This allows lubricant that accumulates on the backboards 11 to drop from the edges thereof and prevents the lubricant from flowing to the outer surfaces of the cover frames 4.

The depths of the backboards 11 provided in the respective cover frames 4 vary according to the distances between the backboards 11 and the sliding surface 2a, and are set such that a predetermined gap H is provided between the backboards 11 and the sliding surface 2a. Providing the predetermined gap H prevents the lubricant that drops from the backboards 11 from accumulating on a specific backboard 11. An oil drip board 13 is provided at a lower rear end of the backboard 11. The oil drip board 13 prevents the lubricant that accumulates on the upper surface of the backboard 11 from reaching the lower surface of the backboard 11 and allows the lubricant to easily drop.

The sliding shoes 12 are arranged in multiple positions, as shown in FIG. 3, and are provided such that the gaps between the cover frames 4, 4 in front of and behind the sliding shoes 12 are maintained to be predetermined width and that the overlapped cover frames 4 slide without causing no backlash between them. The sliding shoes 12 are formed of a metal, such as brass, that is softer than the slide cover 3 formed of steel.

The backboards 11 may be slightly tilted downward toward the rear to prevent accumulation of the lubricant. The gap H may be formed as a narrow space as long as the space is large enough for the lubricant to flow down on the sliding surface 2a.

The lowermost cover frame 4a has a bottom plate 14 at a lower end thereof to be connected to the column 2. The bottom plate 14 is continuously formed by bending the cover frame 4a in a generally U shape, and is fixed to the column with a bolt. The bottom plate 14 also forms an oil receiving pan 15 to collect the lubricant.

The uppermost cover frame 4d does not have a backboard at an upper end thereof, and has a fixing plate 17 to be fixed to the cross rail 1 with a screw. The fixing plate 17 is formed so as to tightly fit to the lower surface of the cross rail 1 and fixed with a blot.

The protective device for a sliding surface with the above configuration has effects on the lubricant and the cutting fluid as follows. As FIG. 1 shows, most of the lubricant that flows to the sliding surface 2a flows on the sliding surface 2a and the column 2 into the oil receiving pan 15. The lubricant that spatters toward the slide cover 3 adheres on the backboards 11, and then drops from the ends of the backboards 11 into the oil receiving pan 15.

Meanwhile, the cutting fluid that adheres to the outer surface of the slide cover 3 is wiped out downward by the wipers 10 as shown in FIG. 2, and then drops below the slide cover 3.

As described above, the predetermined gap H is formed between each of the backboards 11 and the sliding surface 2a, and thus the sliding surface 2a does not contact the cover frames 4. Therefore, the lubricant that flows from the cross rail 1 to the sliding surface 2a does not flow to the cover frames 4, and if the lubricant on the sliding surface 2a spatters toward the cover frames 4, the lubricant is received by the backboards 11 and drops below the sliding surface 2a. Accordingly, the lubricant does not flow to the outside of the cover frames 4.

Meanwhile, the cutting fluid that adheres to the outer surfaces of the cover frames 4 does not enter the inside of the slide cover 3, and thus is not mixed with the lubricant inside the cover frames 4. Therefore, it is possible to collect the lubricant that does not contain the cutting fluid and chips, and it is also possible to prevent the cutting fluid from being mixed with the lubricant.

In addition, with the sliding shoes 12 provided in the upper portions of the cover frames 4, it is possible to prevent the overlapped cover frames from becoming apart from each other due to deflection, etc., and resulting in formation of gaps, and to prevent the backboards 11 from contacting the sliding surface 2a. Therefore, the cutting fluid does not enter from the front of the cover frames 4 and the lubricant that flows on the sliding surface 2a does not flow to the backboards 11.

Moreover, because the oil receiving pan 15 that collects the lubricant is formed integrally with the cover frame 4a, the oil receiving pan 15 is separated from the outside of the slide cover 3. Thus, the lubricant does not flow to the outside and the cutting fluid that adheres to the slide cover 3 does not enter the oil receiving pan 15.

In the above embodiment, the cover frames 4 are formed so as to have the side portions that extend to the back of the column 2. However, the cover frames 4 may not have such a depth as to extend to the back of the column 2. The cover frames 4 can be telescopically connected even if right and left ends of the cover frames 4 are bent to form a generally small U shape. This structure satisfactorily allows the slide cover 3 to extend and contract, to protect the sliding surface 2a, and moreover, to prevent the lubricant and the cutting fluid from being mixed with each other.

The sliding shoes 12 are provided on four surfaces, namely, the front, left, right and back surfaces, of each of the cover frames 4a to 4c. However, the sliding shoes 12 may be provided at least on the outer surfaces to prevent the backboards 11 from contacting the sliding surface 2a because the lowermost cover frame 4a and the uppermost cover frame 4d are fixed.

What is claimed is:

1. A protective device for a sliding surface, comprising:
a slide cover that includes a plurality of cover frames overlapped and connected, that is provided so as to cover a portion of a sliding surface located below a movable body, the sliding surface allowing the movable body to move in a vertical direction, that extends and contracts as the movable body moves, and that protects the sliding surface from chips and cutting fluid; wherein
each of the cover frames has, at a lower end thereof, a wiper that contacts an outer surface of the each cover frame which is located immediate inside, and has, on an upper inner surface thereof, a backboard that is formed in a roof shape and extends over the cover frame inside, and
the backboard is provided slightly below an upper end of the cover frame, with such a depth that a predetermined gap is formed between the sliding surface and the backboard.

2. The protective device for a sliding surface according to claim 1, wherein
the cover frames each have side portions which are formed by bending left and right ends of the cover frame to cover left and right sides of a base in which the sliding surface is formed,
the cover frames are telescopically connected, and
each of the cover frames is provided, on an upper outer surface thereof, with a sliding shoe that contacts the cover frame which is located immediate outside.

3. The protective device for a sliding surface according to claim 1, wherein
the innermost cover frame among the cover frames has, at a lower end thereof, a bottom plate that is connected to the base in which the sliding surface is formed, and
the bottom plate also serves as an oil receiving portion that encloses an area below the sliding surface and receives lubricant that flows from the sliding surface.

4. The protective device for a sliding surface according to claim 2, wherein
the innermost cover frame among the cover frames has, at a lower end thereof, a bottom plate that is connected to the base in which the sliding surface is formed, and
the bottom plate also serves as an oil receiving portion that encloses an area below the sliding surface and receives lubricant that flows from the sliding surface.
